(19) United States
(12) Patent Application Publication
(10) Pub. No.: US 2009/0303281 A1
(43) Pub. Date: Dec. 10, 2009

(54) BLOTTING FILLISTER STRUCTURE AND PAPER CARRYING APPARATUS

(75) Inventors: Tsung-Fu Kao, Taipei County (TW); Chih-Hwa Wang, Taipei County (TW); Chin-Chang Ho, Taipei County (TW)

Correspondence Address: J C PATENTS, 4 VENTURE, SUITE 250, IRVINE, CA, 92618, US

(73) Assignee: Kinpo Electronics, Inc., Taipei County (TW)

(21) Appl. No.: 12/250,746

(22) Filed: Oct. 14, 2008

(30) Foreign Application Priority Data
Jun. 6, 2008 (TW) 97121250

(51) Int. Cl. B41J 2/165

(52) U.S. Cl. 347/31

(57) ABSTRACT

A blotting fillister structure including a first side, a second side and a blotting area is provided. The first side has a first lead-angle surface. The second side opposite to the first side has a second lead-angle surface. The blotting area is located between the first side and the second side. A width of the first lead-angle surface is greater than a width of the second lead-angle surface.

### CROSS-REFERENCE TO RELATED APPLICATION

This application claims the priority benefit of Taiwan application serial no. 97121250, filed Jun. 6, 2008. The entirety of the above-mentioned patent application is hereby incorporated by reference herein and made a part of this specification.

### BACKGROUND OF THE INVENTION

1. Field of the Invention

The present invention is related to a blotting fillister structure and a paper carrying apparatus and more particularly to a blotting fillister structure adapted to a printer for its full-layout printing and a paper carrying apparatus equipped with such blotting fillister structure.

2. Description of Related Art

With the popularization of personal computers, the market for computer paraphernalia keeps blooming. Consequently, new computer paraphernalia continue to be developed to cater to all varieties of demands from different users. As to computer image output equipments, common equipments include display devices and printers. Printers are classified into laser printers, inkjet printers and thermal wax-transfer printers. As the technology of printers advances, the image quality and resolution of the printout have significantly improved and prices for printers are getting more and more affordable as well. Accordingly, the demand for printers from users keeps increasing.

Taking an inkjet printer for example, the printout range on a paper for general inkjet printers is limited and most inkjet printers set margins on each side of the paper (the areas left blank not to be printed on the margins of a document) such that the number of deformed papers after inkjet printing can be reduced and thereby facilitating conveyance of paper inside the printer. However, if paper is required to be fully printed (usually in photograph printing), the printout range of the paper is usually set manually to exceed the normal range so that the printout range is larger than the size of the paper. Since the printout range is larger, the paper upon inkjet printing would deform to a greater extent due to moisture. When the paper is conveyed inside the printer, the deformed paper tends to bump into the fillister structure which stores surplus ink and warps, which in turn would cause the paper to be jammed inside and damage the printer.

### SUMMARY OF THE INVENTION

The present invention provides a blotting fillister structure and a paper carrying apparatus. A width of a first lead-angle surface is greater than a width of a second lead-angle surface so as to facilitate smooth conveyance of paper while a printer is performing full-layout printing.

The present invention provides a blotting fillister structure and a paper carrying apparatus. A width of a first lead-angle surface is equal to a width of a second lead-angle surface so as to facilitate smooth conveyance of paper while a printer is performing full-layout printing.

The present invention provides a blotting fillister structure including a first side, a second side and a blotting area. The first side has a first lead-angle surface. The second side is opposite to the first side, and the second side has a second lead-angle surface. The first blotting area is located between the first side and the second side. The width of the first lead-angle surface is greater than the width of the second lead-angle surface.

According to an embodiment of the present invention, the first side further has a first sidewall and the second side further has a second sidewall. The first sidewall is connected to the first blotting area and the first lead-angle surface. The second sidewall is connected to the first blotting area and the second lead-angle surface.

According to an embodiment of the present invention, the depth of the first sidewall is less than the depth of the second sidewall.

According to an embodiment of the present invention, the second side further has a second sidewall. The second sidewall is connected to the first blotting area and the second lead-angle surface.

The present invention provides a blotting fillister structure including a first side, a second side and a blotting area. The first side has a first lead-angle surface. The second side is opposite to the first side, and the second side has a second lead-angle surface. The first blotting area is located between the first side and the second side. The width of the first lead-angle surface is substantially equal to the width of the second lead-angle surface.

According to an embodiment of the present invention, the first side further has a first sidewall and the second side further has a second sidewall. The first sidewall is connected to the first blotting area and the first lead-angle surface. The second sidewall is connected to the first blotting area and the second lead-angle surface.

According to an embodiment of the present invention, the depth of the first sidewall is substantially equal to the depth of the second sidewall.

The present invention provides a paper carrying apparatus having a carrying area, a first peripheral area and a second peripheral area. The carrying area is located between the first peripheral area and the second peripheral area. The paper carrying apparatus includes a first blotting fillister structure and a second blotting fillister structure. The first blotting fillister structure is located between the carrying area and the first peripheral area and includes a first side, a second side and a first blotting area. The first side has a first lead-angle surface, and the first lead-angle surface is connected to the first peripheral area. The second side is opposite to the first side, and the second side has a second lead-angle surface. The second lead-angle surface is connected to the carrying area. The first blotting area is located between the first side and the second side.

The second blotting fillister structure is located between the carrying area and the second peripheral area and includes a third side, a fourth side and a second blotting area. The third side has a third lead-angle surface, and the third lead-angle surface is connected to the carrying area. The fourth side is opposite to the third side and has a fourth lead-angle surface. The fourth lead-angle surface is connected to the second peripheral area. The second blotting area is located between the third side and the fourth side. The width of the first lead-angle surface is greater than the width of the second lead-angle surface. The width of the fourth lead-angle surface is greater than the width of the third lead-angle surface.

According to an embodiment of the present invention, the first side further has a first sidewall; the second sidewall further has a second sidewall; the third side further has a third sidewall; the fourth side further has a fourth sidewall. The first sidewall is connected to the first blotting area and the first lead-angle surface. The second sidewall is connected to the first blotting area and the second lead-angle surface. The third sidewall is connected to the second blotting area and the third lead-angle surface. The fourth sidewall is connected to the second blotting area and the fourth lead-angle surface.

According to an embodiment of the present invention, the depth of the first sidewall is less than the depth of the second sidewall, and the depth of the fourth sidewall is less than the depth of the third sidewall.

According to an embodiment of the present invention, the second side further has a second sidewall and the fourth side further has a fourth sidewall. The second sidewall is connected to the first blotting area and the second lead-angle surface. The fourth sidewall is connected to the second blotting area and the fourth lead-angle surface.

The present invention provides a paper carrying apparatus having a carrying area, a first peripheral area and a second peripheral area. The carrying area is located between the first peripheral area and the second peripheral area. The paper carrying apparatus includes a first blotting fillister structure and a second blotting fillister structure. The first blotting fillister structure is located between the carrying area and the first peripheral area and includes a first side, a second side and a first blotting area. The first side has a first lead-angle surface, and the first lead-angle surface is connected to the first peripheral area. The second side is opposite to the first side and has a second lead-angle surface. The second lead-angle surface is connected to the carrying area. The first blotting area is located between the first side and the second side.

The second blotting fillister structure is located between the carrying area and the second peripheral area and includes a third side, a fourth side and a second blotting area. The third side has a third lead-angle surface, and the third lead-angle surface is connected to the carrying area. The fourth side is opposite to the third side and has a fourth lead-angle surface. The fourth lead-angle surface is connected to the second peripheral area. The second blotting area is located between the third side and the fourth side. The width of the first lead-angle surface is substantially equal to the width of the second lead-angle surface. The width of the fourth lead-angle surface is substantially equal to the width of the third lead-angle surface.

According to an embodiment of the present invention, the first side further has a first sidewall; the second side further has a second sidewall; the third side further has a third sidewall; the fourth side further has a fourth sidewall. The first sidewall is connected to the first blotting area and the first lead-angle surface. The second sidewall is connected to the first blotting area and the second lead-angle surface. The third sidewall is connected to the second blotting area and the third lead-angle surface. The fourth sidewall is connected to the second blotting area and the fourth lead-angle surface.

According to an embodiment of the present invention, the depth of the first sidewall is substantially equal to the depth of the second sidewall, and the depth of the third sidewall is substantially equal to the depth of the fourth sidewall.

In the present invention, since the width of the first lead-angle surface is greater than the width of the second lead-angle surface and the width of the fourth lead-angle surface is greater than the width of the third lead-angle surface, when full-layout printing is performed on paper, the inkjet-printed paper smoothly passes through the first blotting fillister structure and the second blotting fillister structure. Therefore, the blotting fillister structure and the paper carrying apparatus of the present invention increase the speed and smoothness of conveying paper inside the printer and thereby enhance convenience for users. Moreover, since the process of transmitting paper goes more smoothly, the reliability and durability of the printer is improved as well.

In order to make the above and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view showing a paper carrying apparatus applied to a printer according to an embodiment of the present invention.

FIG. 1B is a partially enlarged schematic view showing the first blotting fillister structure and the second blotting fillister structure of FIG. 1A.

FIG. 1C is a schematic view showing a piece of paper lain over the carrying area and the second blotting fillister structure of FIG. 1A.

FIG. 1D is a schematic view showing a piece of paper lain over the carrying area and the first blotting fillister structure of FIG. 1A.

FIG. 2 is a partially enlarged schematic view of a first blotting fillister structure and a second blotting fillister structure according to another embodiment of the present invention.

FIG. 3A is a schematic view showing a paper carrying apparatus applied to a printer according to another embodiment of the present invention.

FIG. 3B is a partially enlarged schematic view showing the first blotting fillister structure and the second blotting fillister structure of FIG. 3A.

FIG. 3C is a schematic view showing a piece of paper lain over the carrying area and the second blotting fillister structure of FIG. 3A.

FIG. 3D is a schematic view showing a piece of paper lain over the carrying area and the first blotting fillister structure of FIG. 3A.

### DESCRIPTION OF EMBODIMENTS

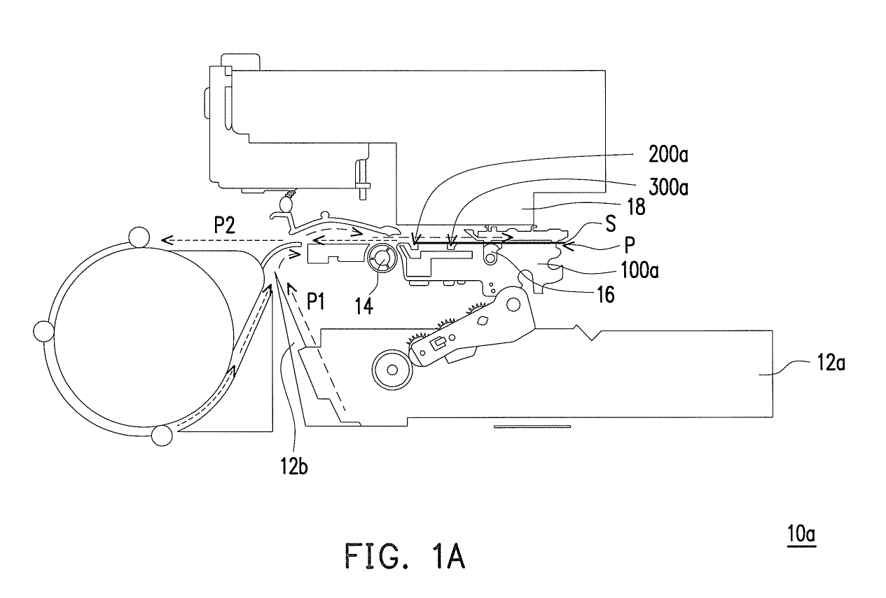

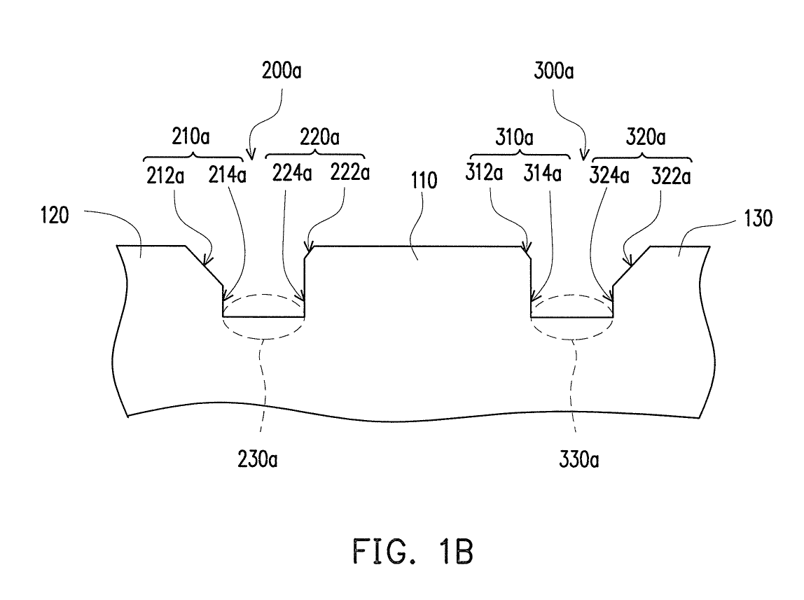

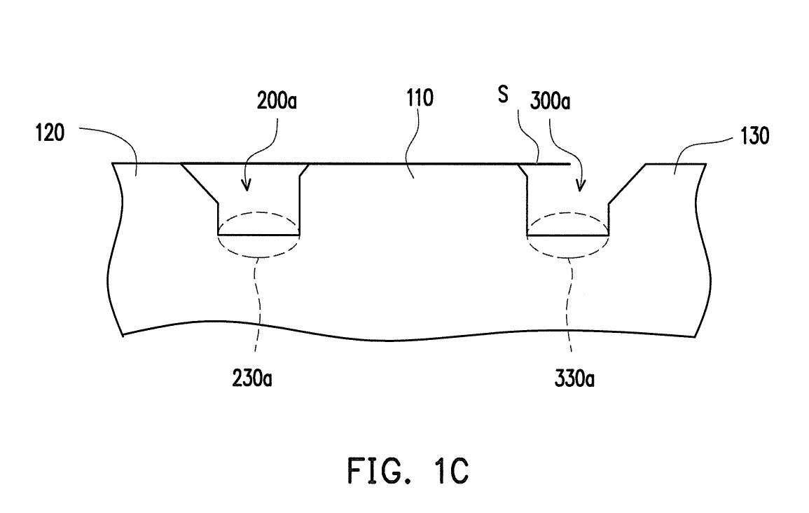

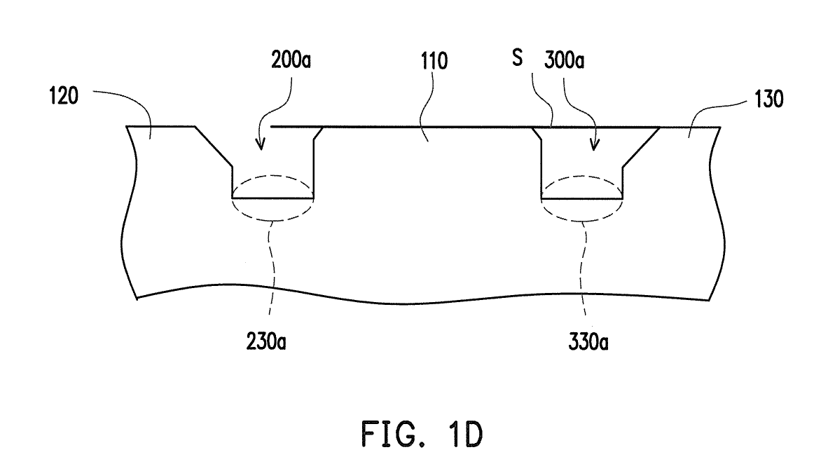

FIG. 1A is a schematic view showing a paper carrying apparatus applied to a printer according to an embodiment of the present invention. FIG. 1B is a partially enlarged schematic view of a first blotting fillister structure and a second blotting fillister structure of FIG. 1A. It should be noted that in order to facilitate explanation some components are omitted from FIG. 1B. Referring to both FIGS. 1A and 1B simultaneously, according to the present embodiment, a paper carrying apparatus 100a is suitable for being assembled inside a printer 10a to perform double-page full-layout printing on a piece of paper S. A design of the blotting fillister structure in the paper carrying apparatus 100a facilitates smooth conveyance of the paper S inside the printer 10a after full-layout printing is completed.

The paper carrying apparatus 100a has a carrying area 110, a first peripheral area 120 and a second peripheral area 130. The carrying area 110 is located between the first peripheral area 120 and the second peripheral area 130. The paper carrying apparatus 100a includes a first blotting fillister structure 200a and a second blotting fillister structure 300a. The first blotting fillister structure 200a is located between the carrying area 110 and the first peripheral area 120. The second blotting fillister structure 300a is located between the carrying area 110 and the second peripheral area 130.

In more detail, the first blotting fillister structure 200a includes a first side 210a, a second side 220a and a first blotting area 230a. The first side 210a has a first lead-angle surface 212a, and the first lead-angle surface 212a is connected to the first peripheral area 120. The second side 220a is opposite to the first side 210a. The second side 220a has a second lead-angle surface 222a and the second lead-angle surface 222a is connected to the carrying area 110. The width of the first lead-angle surface 212a is greater than the width of the second lead-angle surface 222a. The first blotting area 230a is located between the first side 210a and the second side 220a for blotting surplus ink.

The second blotting fillister structure 300a includes a third side 310a, a fourth side 320a and a second blotting area 330a. The third side 310a has a third lead-angle surface 312a, and the third lead-angle surface 312a is connected to the carrying area 110. The fourth side 320a is opposite to the third side 310a. The fourth side 320a has a fourth lead-angle surface 322a and the fourth lead-angle surface 322a is connected to the second peripheral area 130. The width of the fourth lead-angle surface 322a is greater than the width of the third lead-angle surface 312a. The second blotting area 330a is located between the third side 310a and the fourth side 320a for blotting surplus ink.

Moreover, according to the present embodiment, the first side 210a of the first blotting fillister structure 200a further has a first sidewall 214a, and the second side 220a of the first blotting fillister structure 200a further has a second sidewall 224a. The first sidewall 214a is connected to the first blotting area 230a and the first lead-angle surface 212a. The second sidewall 224a is connected to the first blotting area 230a and the second lead-angle surface 222a. The depth of the first sidewall 214a is less than the depth of the second sidewall 224a.

The third side 310a of the second blotting fillister structure 300a further has a third sidewall 314a, and the fourth side 320a of the second blotting fillister structure 300a further has a fourth sidewall 324a. The third sidewall 314a is connected to the second blotting area 330a and the third lead-angle surface 312a. The fourth sidewall 324a is connected to the second blotting area 330a and the fourth lead-angle surface 322a. The depth of the fourth sidewall 324a is less than that of the third sidewall 314a.

It should be noted that according to the present embodiment, the first blotting fillister structure 200a and the second blotting fillister structure 300a are mirror reflections of each other. In other words, a structural form of the first side 210a of the first blotting fillister structure 200a is substantially equal to a structural form of the fourth side 320a of the second blotting fillister structure 300a; the structural form of the second side 220a of the first blotting fillister structure 200a is substantially equal to that of the third side 310a of the second blotting fillister structure 300a. The depth of the first sidewall 214a is substantially equal to the depth of the fourth sidewall 324a. The depth of the second sidewall 224a is substantially equal to the depth of the third sidewall 314a.

Furthermore, referring to FIG. 1A again, the printer 10a performs printing on the paper S as follows. First, a piece of paper S is retrieved from a plurality of pieces of paper in a paper folder 12a to be entered into a first channel P1 through a paper feeding device 12b. The paper S is then conveyed to an area right under an inkjet printing device 18 through transmission of a printing roller 14 and an active roller 16. In other words, the paper S is located in the carrying area 110 and a front portion of the paper S reaches in the air over the second blotting fillister structure 300a (referring to FIG. 1C) such that exceeding inkjet printing is performed on the front portion of the paper S. Afterwards, the printing roller 14 and the active roller 16 convey the paper S towards the second blotting fillister structure 300a and a rear portion of the paper S reaches in the air over the first blotting fillister structure 200a (referring to FIG. 1D) such that exceeding inkjet printing is performed on the rear portion of the paper S.

When the inkjet printing device 18 completes inkjet printing on a first side of the paper S, the printing roller 14 and the active roller 16 convey the rear portion of the paper S to the first peripheral area 120 to wait for the paper S to dry up. Next, the printing roller 14 and the active roller 16 convey the paper S through the first peripheral area 120, the carrying area 110, and the second peripheral area 130 to a paper outlet P so as to complete full-layout printing on a first side of the paper S.

Thereafter, through transmission of the printing roller 14 and the active roller 16, the paper S is conveyed from the paper outlet P through the second peripheral area 130, the carrying area 110 and the first peripheral area 120 to a second channel P2 so as to perform full-layout printing on a second side of the paper S. The paper S then re-enters through the second channel P2 to be placed in the carrying area 110 right under the inkjet printing device 18, the front portion of the paper S reaches in the air over the second blotting fillister structure 300a (referring to FIG. 1C) so that exceeding inkjet printing is performed on the front portion of the paper S. Afterwards, the printing roller 14 and the active roller 16 convey the paper S towards the second blotting fillister structure 300a and the rear portion of the paper S reaches in the air over the first blotting fillister structure 200a (referring to FIG. 1D) so that exceeding inkjet printing is performed on the rear portion of the paper S.

Finally, when the inkjet printing device 18 completes inkjet printing on the second side of the paper S, the printing roller 14 and the active roller 16 convey the rear portion of the paper S to the first peripheral area 110 to wait for the paper S to dry up. Next, the printing roller 14 and the active roller 16 convey the paper S through the first peripheral area 120, the carrying area 110 and the second peripheral area 130 to the paper outlet P so as to complete full-layout printing on the second side of the paper S. Until this step, double-page full-layout printing of the paper S has been completed.

In brief, according to the present embodiment, since the width of the first lead-angle surface 212a is greater than the width of the second lead-angle surface 222a and the width of the fourth lead-angle surface 322a is greater than the width of the third lead-angle surface 312a, when the printing roller 14 and the active roller 16 convey the moist paper S after being inkjet-printed back and forth among the first peripheral area 120, the carrying area 110 and the second peripheral area 130, the paper S does not bump into the first blotting fillister structure 200a or the second blotting fillister structure 300a because the paper S has deformed. In other words, the paper carrying apparatus 100a of the present embodiment smoothly conveys the paper S back and forth among the first peripheral area 120, the carrying area 110 and the second peripheral area 130 and prevents the printer from being damaged because paper bumps into the fillister structure and gets jammed as occurring in prior art.

Moreover, when full-layout printing is performed on the paper S, the paper S after being inkjet-printed can smoothly pass through the first blotting fillister structure 200a and the second blotting fillister structure 300a. Therefore, the paper carrying apparatus of the present embodiment increases the speed and smoothness of conveying paper inside the printer and thereby enhances convenience for users. Moreover, since the process of conveying paper S goes more smoothly, the reliability and durability of the printer 10a is improved as well.

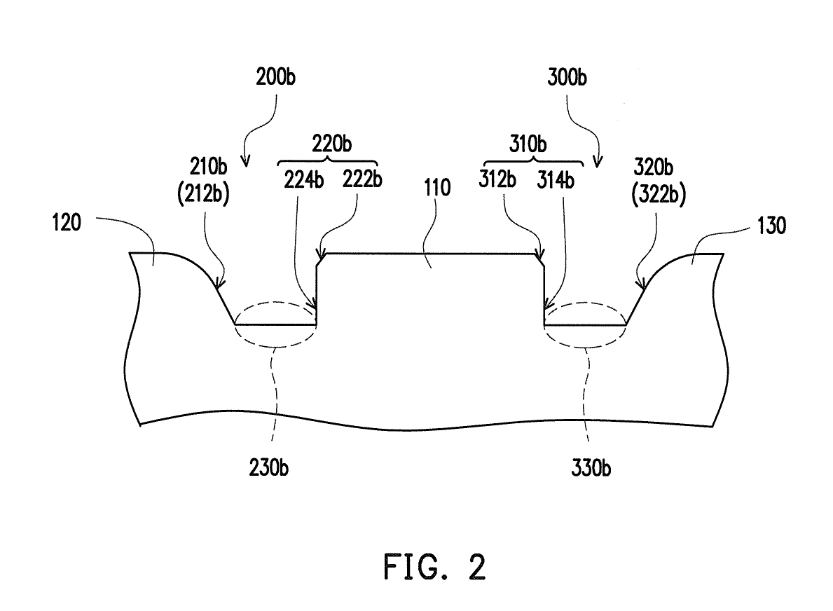

FIG. 2 is a partially enlarged schematic view of a first blotting fillister structure and a second blotting fillister structure according to another embodiment of the present invention. Referring to FIG. 2, a first blotting fillister structure 200b of FIG. 2 includes a first side 210b, a second side 220b and a first blotting area 230b. The first side 210b has a first lead-angle surface 212b, and the first lead-angle surface 212b is connected to the first peripheral area 120. The second side 220b is opposite to the first side 210b. The second side 220b has a second lead-angle surface 222b and the second lead-angle surface 222b is connected to the carrying area 110. The width of the first lead-angle surface 212b is greater than the width of the second lead-angle surface 222b. The first blotting area 230b is located between the first side 210b and the second side 220b for blotting surplus ink.

The second blotting fillister structure 300b includes a third side 310b, a fourth side 320b and a second blotting area 330b. The third side 310b has a third lead-angle surface 312b, and the third lead-angle surface 312b is connected to the carrying area 110. The fourth side 320b is opposite to the third side 310b. The fourth side 320b has a fourth lead-angle surface 322b and the fourth lead-angle surface 322b is connected to the second peripheral area 130. The width of the fourth lead-angle surface 322b is greater than that of the third lead-angle surface 312b. The second blotting area 330b is located between the third side 310b and the fourth side 320b for blotting surplus ink.

Furthermore, according to the present embodiment, the second side 220b of the first blotting fillister structure 200b further has a second sidewall 224b, and the fourth side 320b of the second blotting fillister structure 300b further has a fourth sidewall 324b. In detail, the second sidewall 224b is connected to the first blotting area 230b and the second lead-angle surface 222b, and the fourth sidewall 324b is connected to the second blotting area 330b and the fourth lead-angle surface 322b.

Specifically, according to the present embodiment, the first lead-angle surface 212b of the first side 210b is directly connected to the first blotting area 230b, and the fourth lead-angle surface 322b of the fourth side 320b is directly connected to the second blotting area 330b. The width of the first lead-angle surface 212b is greater than the width of the second lead-angle surface 222b and the first lead-angle surface 212b is a smooth arc surface. The width of the fourth lead-angle surface 322b is greater than the width of the third lead-angle surface 312b and the fourth lead-angle surface 322b is a smooth arc surface. Hence, the paper S (referring to FIG. 1A) can be smoothly conveyed back and forth among the first peripheral area 120, the carrying area 110 and the second peripheral area 130 such that the printer 10a (referring to FIG. 1A) avoids being damaged because the paper gets jammed from bumping into the fillister structure as occurring in prior art.

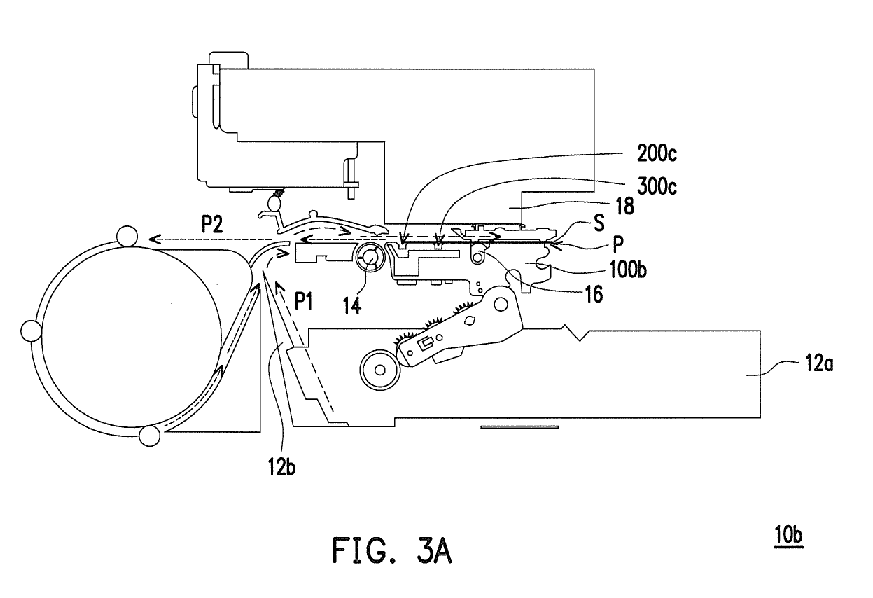

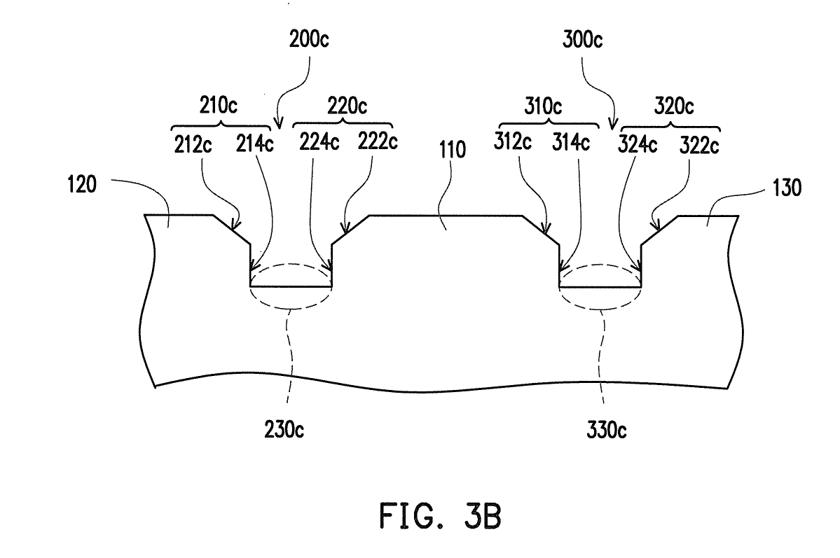

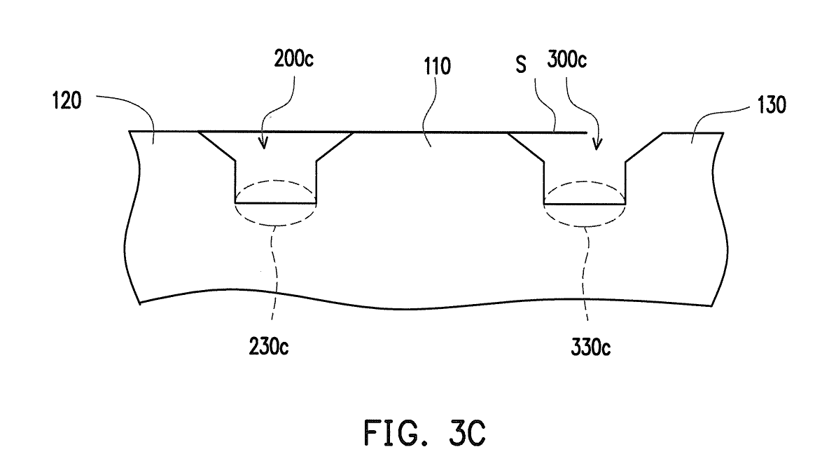

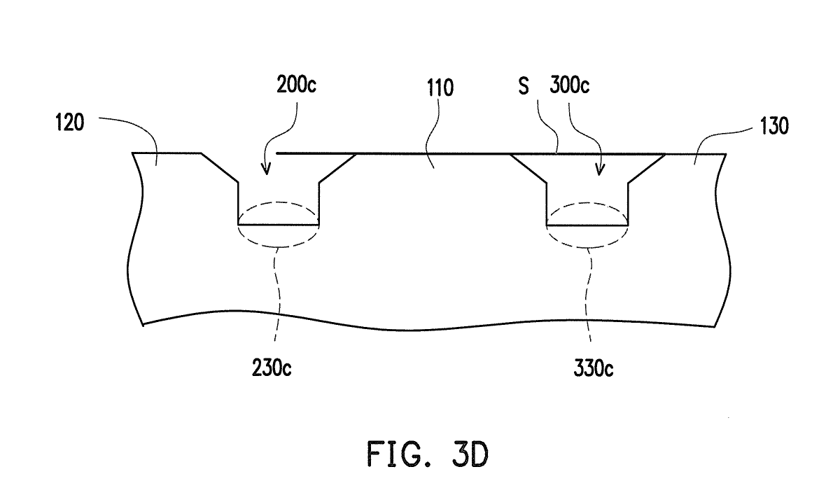

FIG. 3A is a schematic view showing a paper carrying apparatus applied to a printer according to an embodiment of the present invention. FIG. 3B is a partially enlarged schematic view of the first blotting fillister structure and the second blotting fillister structure of FIG. 3A. It should be noted that in order to facilitate explanation some components are omitted from FIG. 3B. Referring to both FIGS. 3A and 3B simultaneously, according to the present embodiment, the paper carrying apparatus 100b has a carrying area 110, a first peripheral area 120 and a second peripheral area 130. The carrying area 110 is located between the first peripheral area 120 and the second peripheral area 130. The paper carrying apparatus 100b includes a first blotting fillister structure 200c and a second blotting fillister structure 300c. The first blotting fillister structure 200c is located between the carrying area 110 and the first peripheral area 120. The second blotting fillister structure 300c is located between the carrying area 110 and the second peripheral area 130.

In more detail, the first blotting fillister structure 200c includes a first side 210c, a second side 220c and a first blotting area 230c. The first side 210c has a first lead-angle surface 212c, and the first lead-angle surface 212c is connected to the first peripheral area 120. The second side 220c is opposite to the first side 210c. The second side 220c has a second lead-angle surface 222c and the second lead-angle surface 222c is connected to the carrying area 110. The width of the first lead-angle surface 212c is substantially equal to the width of the second lead-angle surface 222c. The first blotting area 230c is located between the first side 210c and the second side 220c for blotting surplus ink.

The second blotting fillister structure 300c includes a third side 310c, a fourth side 320c and a second blotting area 330c. The third side 310c has a third lead-angle surface 312c, and the third lead-angle surface 312c is connected to the carrying area 110. The fourth side 320c is opposite to the third side 310c. The fourth side 320c has a fourth lead-angle surface 322c and the fourth lead-angle surface 322c is connected to the second peripheral area 130. The width of the fourth lead-angle surface 322c is substantially equal to the width of the third lead-angle surface 314c. The second blotting area 330c is located between the third side 310c and the fourth side 320c for blotting surplus ink.

Moreover, according to the present embodiment, the first side 210c of the first blotting fillister structure 200c further has a first sidewall 214c, and the second side 220c of the first blotting fillister structure 200c further has a second sidewall 224c. The first sidewall 214c is connected to the first blotting area 230c and the first lead-angle surface 212c. The second sidewall 224c is connected to the first blotting area 230c and the second lead-angle surface 222c. The depth of the first sidewall 214c is substantially equal to the depth of the second sidewall 224c.

The third side 310c of the second blotting fillister structure 300c further has a third sidewall 314c, and the fourth side 320c of the second blotting fillister structure 300c further has a fourth sidewall 324c. The third sidewall 314c is connected to the second blotting fillister structure 330c and the third lead-angle surface 312c. The fourth sidewall 324c is connected to the second blotting fillister structure 330c and the fourth lead-angle surface 322c. The depth of the third sidewall 314c is substantially equal to the depth of the fourth sidewall 324c.

It should be noted that according to the present embodiment a structural form of the first blotting fillister structure 200c is substantially the same as a structural form of the second blotting fillister structure 300c. The structural forms of the first side 210c and the second side 220c of the first blotting fillister structure 200c are substantially the same. The structural forms of the third side 310c and the fourth side 320c of the second blotting fillister structure 300c are substantially the same. In other words, the first side 210c and the second side 220c of the first blotting fillister structure 200c are parallel structures; the third side 310c and the fourth side 320c of the second blotting fillister structure 300c are parallel structures. The first blotting fillister structure 200c and the second blotting fillister structure 300c are the same structures.

Furthermore, referring to FIG. 3A again, the printer 10b performs printing on the paper S as follows. First, a piece of paper S is retrieved from a plurality of pieces of paper in a paper folder 12a to be entered into a first channel P1 through a paper feeding device 12b. The paper S enters a first channel P1 through the paper feeding device 12b and is conveyed to an area right under an inkjet printing device 18 through transmission of a printing roller 14 and an active roller 16. In other words, the paper S is placed in the carrying area 110 and a front portion of the paper S reaches in the air over the second blotting fillister structure 300c (referring to FIG. 3C) such that exceeding inkjet printing is performed on the front portion of the paper S. Afterwards, the printing roller 14 and the active roller 16 convey the paper S towards the second blotting fillister structure 300c and a rear portion of the paper S reaches in the air over the first blotting fillister structure 200c (referring to FIG. 3D) such that exceeding inkjet printing is performed on the rear portion of the paper S.

When the inkjet printing device 18 completes inkjet printing on the first side of the paper S, the printing roller 14 and the active roller 16 convey the rear portion of the paper S to the first peripheral area 110 to wait for the paper S to dry up. Next, the printing roller 14 and the active roller 16 convey the paper S through the first peripheral area 120, the carrying area 110 and the second peripheral area 130 to the paper outlet P so as to complete full-layout printing on the first side of the paper S.

Thereafter, the printing roller 14 and the active roller 16 convey the paper S from the paper outlet P through the second peripheral area 130, the carrying area 110 and the first peripheral area 120 to a second channel P2 so as to perform full-layout printing on the second side of the paper S. When the paper S re-enters through the second channel P2 to be placed in the carrying area 110 right under the inkjet printing device 18, the front portion of the paper S reaches in the air over the second blotting fillister structure 300c (referring to FIG. 3C) so that exceeding inkjet printing is performed on the front portion of the paper S. Then, the printing roller 14 and the active roller 16 convey the paper S towards the second blotting fillister structure 300c and the rear portion of the paper S reaches in the air over the first blotting fillister structure 200c (referring to FIG. 3D) so that exceeding inkjet printing is performed on the rear portion of the paper S.

Finally, when the inkjet printing device 18 completes inkjet printing on the second side of the paper S, the printing roller 14 and the active roller 16 convey the rear portion of the paper S to the first peripheral area 110 to wait for the paper S to dry up. Next, the printing roller 14 and the active roller 16 convey the paper S through the first peripheral area 120, the carrying area 110 and the second peripheral area 130 to the paper outlet P so as to complete full-layout printing on the second side of the paper S. Until this step, double-page full-layout printing of the paper S has been completed.

In brief, according to the present embodiment, since the width of the first lead-angle surface 212c is equal to that of the second lead-angle surface 222c and the width of the fourth lead-angle surface 322c is equal to that of the third lead-angle surface 312c, when the printing roller 14 and the active roller 16 convey the moist paper S after being inkjet-printed back and forth among the first peripheral area 120, the carrying area 110 and the second peripheral area 130, the paper S does not bump into the first blotting fillister structure 200c or the second blotting fillister structure 300c because the paper S has deformed. In other words, the paper carrying apparatus 100c of the present embodiment smoothly conveys the paper S back and forth among the first peripheral area 120, the carrying area 110 and the second peripheral area 130 and prevents the printer from being damaged because paper bumps into the fillister structure and gets jammed as occurring in prior art.

Moreover, after full-layout printing is performed on the paper S, the inkjet-printed paper S smoothly passes through the first blotting fillister structure 200c and the second blotting fillister structure 300c. Therefore, the paper carrying apparatus of the present embodiment increases the speed and smoothness of conveying paper inside the printer and thereby enhances convenience for users. Moreover, since the process of conveying the paper S goes more smoothly, the reliability and durability of the printer 10b is improved as well.

In summary, according to the present invention, since the width of the first lead-angle surface is greater than that of the second lead-angle surface and the width of the fourth lead-angle surface is greater than that of the third lead-angle surface, when full-layout printing is performed on paper, the inkjet-printed paper can smoothly pass through the first blotting fillister structure and the second blotting fillister structure such that the printer is prevented from being damaged by jammed paper because the moist inkjet-printed paper deforms and bumps into the fillister structure. Therefore, the blotting fillister structure and the paper carrying apparatus of the present invention increase the speed and smoothness of conveying paper inside the printer and thereby enhance convenience for users. Moreover, since the process of conveying paper goes more smoothly, the reliability and durability of the printer is improved as well.

It will be apparent to those skilled in the art that various modifications and variations can be made to the structure of the present invention without departing from the scope and spirit of the invention. In view of the foregoing, it is intended that the present invention cover modifications and variations of this invention provided they fall within the scope of the following claims and their equivalents.

What is claimed is:

1. A blotting fillister structure, comprising:
a first side, having a first lead-angle surface;
a second side, being opposite to the first side and having a second lead-angle surface; and
a first blotting area, located between the first side and the second side,
wherein a width of the first lead-angle surface is greater than a width of the second lead-angle surface.

2. The blotting fillister structure as claimed in claim 1, wherein the first side further comprises a first sidewall, the second side further comprising a second sidewall, the first sidewall connected to the first blotting area and the first lead-angle surface, the second sidewall connected to the first blotting area and the second lead-angle surface.

3. The blotting fillister structure as claimed in claim 2, wherein a depth of the first sidewall is less than a depth of the second sidewall.

4. The blotting fillister structure as claimed in claim 1, wherein the second side further comprises a second sidewall and the second sidewall is connected to the first blotting area and the second lead-angle surface.

5. A blotting fillister structure, comprising:
a first side, having a first lead-angle surface;
a second side, being opposite to the first side and having a second lead-angle surface; and
a first blotting area, located between the first side and the second side,
wherein a width of the first lead-angle surface is substantially equal to a width of the second lead-angle surface.

6. The blotting fillister structure as claimed in claim 5, wherein the first side further comprises a first sidewall, the second side further comprising a second sidewall, the first sidewall connected to the first blotting area and the first lead-angle surface, the second sidewall connected to the first blotting area and the second lead-angle surface.

7. The blotting fillister structure as claimed in claim 5, wherein a depth of the first sidewall is substantially equal to a depth of the second sidewall.

8. A paper carrying apparatus, having a carrying area, a first peripheral area and a second peripheral area, the carrying area located between the first peripheral area and the second peripheral area, the paper carrying apparatus comprising:
a first blotting fillister structure, located between the carrying area and the first peripheral area, the first blotting fillister structure comprising:
a first side, having a first lead-angle surface, the first lead-angle surface connected to the first peripheral area;
a second side, being opposite to the first side and having a second lead-angle surface, the second lead-angle surface connected to the carrying area;
a first blotting area, located between the first side and the second side; and
a second blotting fillister structure, located between the carrying area and the second peripheral area, the second blotting fillister structure comprising:
a third side, having a third lead-angle surface, the third lead-angle surface connected to the carrying area;
a fourth side, being opposite to the third side and having a fourth lead-angle surface, the fourth lead-angle surface connected to the second peripheral area;
a second blotting area, located between the third side and the fourth side,
wherein a width of the first lead-angle surface is greater than a width of the second lead-angle surface and the width of the fourth lead-angle surface is greater than the width of the third lead-angle surface.

9. The paper carrying apparatus as claimed in claim 8, wherein the first side further comprises a first sidewall, the second side further comprising a second sidewall, the third side further comprising a third sidewall, the fourth side further comprising a fourth sidewall, the first sidewall connected to the first blotting area and the first lead-angle surface, the second sidewall connected to the first blotting area and the second lead-angle surface, the third sidewall connected to the second blotting area and the third lead-angle surface, the fourth sidewall connected to the second blotting area and the fourth lead-angle surface.

10. The paper carrying apparatus as claimed in claim 9, wherein a depth of the first sidewall is less than a depth of the second sidewall, the depth of the fourth sidewall is less than the depth of the third sidewall.

11. The blotting fillister structure as claimed in claim 8, wherein the second side further comprises a second sidewall, the fourth side further comprising a fourth sidewall, the second sidewall connected to the first blotting area and the second lead-angle surface, the fourth sidewall connected to the second blotting area and the fourth lead-angle surface.

12. A paper carrying apparatus, having a carrying area, a first peripheral area and a second peripheral area, the carrying area located between the first peripheral area and the second peripheral area, the paper carrying apparatus comprising:
a first blotting fillister structure, located between the carrying area and the first peripheral area, the first blotting fillister structure comprising:
a first side, having a first lead-angle surface, the first lead-angle surface connected to the first peripheral area;
a second side, being opposite to the first side and having a second lead-angle surface, the second lead-angle surface connected to the carrying area;
a first blotting area, located between the first side and the second side; and
a second blotting fillister structure, located between the carrying area and the second peripheral area, the second blotting fillister structure comprising:
a third side, having a third lead-angle surface, the third lead-angle surface connected to the carrying area;
a fourth side, being opposite to the third side and having a fourth lead-angle surface, the fourth lead-angle surface connected to the second peripheral area;
a second blotting area, located between the third side and the fourth side,
wherein a width of the first lead-angle surface is substantially equal to a width of the second lead-angle surface and the width of the fourth lead-angle surface is substantially equal to the width of the third lead-angle surface.

13. The paper carrying apparatus as claimed in claim 12, wherein the first side further comprises a first sidewall, the second side further comprising a second sidewall, the third side further comprising a third sidewall, the fourth side further comprising a fourth sidewall, the first sidewall connected to the first blotting area and the first lead-angle surface, the second sidewall connected to the first blotting area and the second lead-angle surface, the third sidewall connected to the second blotting area and the third lead-angle surface, the fourth sidewall connected to the second blotting area and the fourth lead-angle surface.

14. The paper carrying apparatus as claimed in claim 12, wherein a depth of the first sidewall is substantially equal to a depth of the second sidewall, the depth of the third sidewall being substantially equal to the depth of the fourth sidewall.
